(19) United States
(12) Patent Application Publication
(10) Pub. No.: US 2008/0172733 A1
(43) Pub. Date: Jul. 17, 2008

(54) IDENTIFICATION AND VERIFICATION METHOD AND SYSTEM FOR USE IN A SECURE WORKSTATION

(76) Inventors: David Coriaty, West Palm Beach, FL (US); Craig Casey, Ruskin, FL (US)

Correspondence Address: MCHALE & SLAVIN, P.A., 2855 PGA BLVD, PALM BEACH GARDENS, FL, 33410, US

(21) Appl. No.: 11/622,488

(22) Filed: Jan. 12, 2007

(51) Int. Cl. H04L 9/32

(52) U.S. Cl. 726/19

(57) ABSTRACT

The instant invention relates to a method and system for identifying and verifying a user seeking access to a secured workstation. The inventive procedure comprising the following acts. First, the first personal identification data (PIDS) within a wireless identification device is spontaneously detected by a secure workstation when located within a predetermined proximity. Next, at least one database accessible to the workstation is queried to retrieve the first personal identification data set and a second PIDS. The second PIDS contains biometric data corresponding to the user. Once the biometric data from the user is obtained at the point of transaction it is compared with the second PIDS to verify the identity of user. If there is a match, the user is permitted access to the secured workstation.

### FIELD OF THE INVENTION

The present invention relates generally to the field of a secure access system; particularly, a system and method for identifying and verifying a user seeking access to a secured workstation; and most particularly to a system for utilizing a wireless communicator for initiating an identification protocol at an automated teller (ATM) machine.

### BACKGROUND OF THE INVENTION

In the wake of events like the Sep. 11, 2001, attacks and the recent rise in identity theft, biometric security systems have increased in popularity. Biometric-based security systems typically rely on the details of an individual's unique physical characteristics, such as fingerprints, which makes these systems essentially tamper-proof. Moreover, there is no PIN or password to lose, forget, or steal. The processing modules that run these biometric-based systems compare or match the information obtained from a scan of a biometric sample (e.g., fingerprint) to a stored, static digital match template created when the user originally enrolled in the system. The biometric data of each individual is stored in a database accessible to a workstation.

Biometric security systems work well in securing workstations where the pool of authorized users is small (i.e., a small database). That is, the database contains biometric data of authorized individuals limited to a reasonably small number, e.g., about twenty people (e.g., vehicles, personal safes, computers, etc). However, biometric-based systems generally do not work well in systems used by a large number of people (e.g., bank customer list, customer care cards, etc), which require a large database. The time necessary for the workstation to process modules to compare the user's biometric scan against all stored biometric templates within the large database are excessive and impractical.

Currently, biometric-based security systems designed for use by larger populations require the user to enter a personal identifier. This usually means entering their account number, or swiping a magnetic swipe card (automated teller machine (ATM), debit card) and waiting while the workstation processor module retrieves the user's stored biometric template (e.g., fingerprint image) from the database. The user seeking access must be then scanned by the biometric device and compared against the retrieved biometric template. This results in very long processing times, often causing a backup of people waiting to use the workstations in heavy use areas. Despite the advantages of using biometric security systems, the excessive processing times associated with identifying and verifying users have hampered their widespread adoption to date.

Thus, it is the purpose of the present invention to disclose a system for use on a secured workstation that can retrieve a user's records and corresponding biometric data from the database quickly. This identity retrieval process occurs concomitantly as the user approaches the workstation, even before the user interacts with the workstation. Therefore, the wait time is reduced to the time it takes to biometrically scan the user and compare it to the retrieved template. The integration of this system would make the use of ATM's, checkout lines, and other devices faster and easier to use in high traffic areas, while still ensuring security of the transactions.

### DESCRIPTION OF THE PRIOR ART

For example, U.S. Published Application No. 2005/0137977, to Wankmueller discloses a self-validating payment device for making proximity payment transactions through a point-of-sale (POS) device. A biometric reader is integrated into the payment device. A biometric measurement of a user of the payment device in the field is compared internally with a reference biometric measurement corresponding to the user to whom the payment device is registered. Based on positive results of this comparison, the payment device is validated for use by the person attempting to make the proximity transaction. Unlike the present invention, the biometric reader is integrated into the payment device and all the user information is simultaneously transmitted to the payment device. More importantly, there is no pre-identification of the user approaching the POS device followed by additional identification upon reaching the device.

Similarly, U.S. Published Application No. 2005/0114654, Brackett et al., discloses a wireless device, such as a Bluetooth mobility pin is coupled to a biometric device, such as a thumb scanner, providing for wireless communication with a system to which access is desired. The thumb scanner provides a reliable and secure signal based upon biometric measurements, the signal being provided to the pin, which is then uniquely coded to the accessed system. When a workstation or other device having a compatible antenna receives the signal from the pin, the workstation accesses identification data and allows for login of the user based upon the highly secure biometric measurements, and the wireless connection between the pin and the system. The pin will not send the required code unless the coded user of the pin succeeds in scanning the thumb print or other biometric measurement basis. Again, this system differs from the present invention, in that there is no pre-identification of the user approaching the device followed by additional identification upon reaching the device.

U.S. Published Application No. 2003/0200778, to Chhatwal, discloses a biometric electronic key for use with an electronic lock which is programmable to contain data representative of the fingerprint of the user. When so programmed, successful use of the key requires that a fingerprint of the user, as sensed by a fingerprint identification sensor installed in the handle of the key and touched by a user in the course of gripping the key, match an electronic template of an authorized key user's fingerprint that has been programmed into memory within the key's on-board electronics. Otherwise, the key will fail to operate the lock.

While the foregoing described prior art security systems may have advanced the art in a variety of ways, there nevertheless remains a need for a method and system for identifying and verifying a user seeking access to a workstation that concomitantly retrieves the stored biometric records of all users within a predetermined range of the workstation, before the users interact with the workstation.

All patents and publications mentioned in this specification are indicative of the levels of those skilled in the art to which the invention pertains and are herein incorporated by reference to the same extent as if each individual publication was specifically and individually indicated to be incorporated by reference.

### SUMMARY OF THE INVENTION

Consequently, in view of the deficiencies found in the prior art, the present invention is directed to a method and system for identifying and verifying a user seeking access to a secured workstation. Illustrative of the instant inventive procedure are the following acts: (1) creation of a first personal identification dataset containing identification information (e.g., account number, PIN, etc.) and associating said dataset with a wireless identification device (credit/debt card, Identification card, electronic key, etc.), wherein said wireless device is capable of being spontaneously detected by a secure workstation, e.g. an ATM, upon positioning the identification device within a predetermined proximity; (2) querying at least one database accessible to the workstation using said first personal identification data set (PIDS) as a means to retrieve a corresponding second PIDS. The second PIDS containing at least one type of biometric data (fingerprint scan, optical scan, etc) corresponding to the user. Biometric data is then obtained at the point of transaction from a user via at least one biometric device disposed on the workstation. The user obtained biometric data is compared with the second PIDS to verify the identity of the user, thereby permitting user access to the secured workstation.

An objective of the present invention is to teach a system for accelerated polling of an individual's biometric data from a secure system to facilitate rapid retrieval and confirmation of biometric data.

An additional objective of the present invention is to disclose a system and methodology for the identification and verification which may be utilized in any type of workstation that requires restricted access (e.g., safe, computer system, automatic teller machine, vehicle, or the like.)

Another objective of the present invention is to disclose a wireless identification device which spontaneously communicates with a secured workstation upon being positioned within a predetermined proximity thereto.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a block diagram of the identification and verification method in accordance with one embodiment of the present invention.

### DETAILED DESCRIPTION OF THE INVENTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

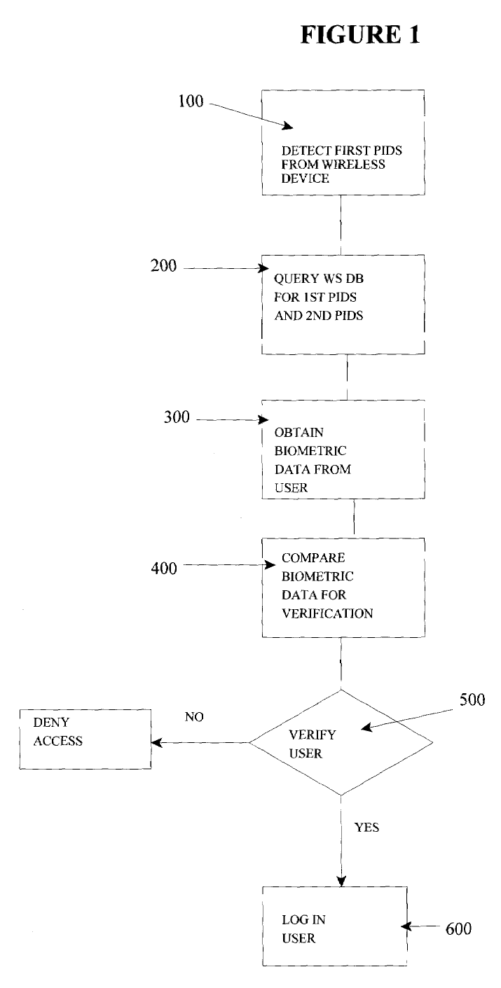

FIG. 1 is a block diagram of the means and associated methodology for identifying and verifying a user accessing a secured workstation according to one embodiment of the present invention. Initially, a user carrying the wireless identification device is detected by the secured workstation, 100. The wireless identification device is first associated with a first personal identification data set (hereinafter, PIDS). The secured workstation has at least one communications port (e.g., antenna) for spontaneously detecting and receiving the first PIDS from the wireless identification device.

The workstation is in communication with at least one database. Once the first PIDS is received by the wireless identification device, the database is queried to receive information matching the first PIDS, 200. Polling of the database using the first PIDS retrieves a second PIDS, which contains previously stored biometric data of the authorized user.

Upon reaching the workstation, the user is prompted to provide the necessary biometric information, 300 (FIG. 1). A biometric scan of the user is performed and the biometric data is compared to the second PIDS, 400. If the obtained biometric data is deemed to match the biometric scan 500, then the user may be logged into the system, 600. If not, the user is denied access, 700.

It is critical that the first PIDS is spontaneously sent to the secured workstation (either passively or actively) when the device is within a predetermined proximity to the workstation so that the user's records are in the process of being retrieved from the database as the user approaches the workstation. Thus, once the user has reached the workstation the user need only present the required biometric scan at the workstation, thereby reducing the overall transaction time at the workstation. Moreover, the present inventive system remains secure even if the wireless identification device is lost and utilization by another unauthorized individual is attempted since the other individual does not match the stored biometric template and, therefore cannot be biometrically verified. Moreover, since the user must be verified, the wireless (over-the-air) transmission of personal identification data does not present an opportunity for a security breach of the workstation. However, any suitable data encryption algorithm capable of encoding transmitted data may be utilized.

The first PIDS may include at least one of, albeit is not limited to, an account number, user name, PIN number, or the like. The wireless identification device of the present invention may be a stand alone device or integrated into other existing wireless devices (e.g., cellular phone, PDA, handheld computer, etc.)

As discussed above, the workstation includes at least one biometric device that is capable of obtaining biometric data from the user seeking access at the point of transaction. According to the present invention, a wide variety of biometric reader types and methodologies may be employed as known in the art and need not be repeated herein (fingerprint scan, handprint scan, facial scan, optical scan, voice recognition, etc).

The system and methodology of the present invention may be utilized in any type of workstation where restricted access is desired. The only limitation is that the workstation should be able to be used in combination with at least one database, biometric reader/scanner and a tag reader capable of receiving the first PIDS from the wireless identification device, as described further below. Examples of suitable workstations could include an automatic teller machine, vehicle, electronic cash register, or the like. The workstation may include at least one interface (keyboard, mouse, finger pad, etc.,) hard drive, memory, and file server as required, which are controlled by the various processing modules as is known in the art.

As mentioned above, the workstation includes at least one database in communication with the workstation. The database contains a first PIDS and a second PIDS. The second PIDS includes at least one type of authorized user biometric data (hand scan, facial scan, optical scan, etc.) previously stored and created when the user originally enrolled in the security system. Obviously, the database(s) should be large enough to serve as repositories of large volumes of data, including scanned biometric image templates. Any suitable hardware and/or software necessary for querying and obtaining storage biometric images within the database may be used.

The workstation is in communication with one or more processing modules. The processing module includes electronic circuitry, software, and/or hardware capable of comparing the user obtained biometric data with the appropriate second PIDS (e.g., pre-stored user biometric data) in order to verify the user. If the scanned biometric data obtained at the point of transaction is deemed to match the pre-stored, static template, the workstation allows for login of the user. If the scanned data does not match the user template, the user is denied access. If the user is denied, the workstation may include a separate means to alert the proper authorities (store personnel, police, etc).

Any type of wireless technology may be used which is capable of spontaneously transmitting the first PIDS from the wireless device to the one communications port in the workstation, upon entry of the device within a predetermined proximity of the workstation. For example, an active tag or passive tag may be incorporated on the wireless identification device. Active tags (e.g., radio frequency identification tag (RFID)) are equipped with a battery that can be used as a partial or complete source of power for the tag's circuitry and transmission antenna. Passive tags do not contain a power source (battery) and only respond to an electromagnetic wave signal emitted from a tag reader inside the workstation, thus, this type of tag remains readable for a very long time. However, passive tags can be read only at very short distances, typically a few feet at most. Conversely, active tags can be read at a distance of one hundred feet or more, providing ample time for the workstation to obtaining biometric data from the user seeking access to the secured workstation. Both types of wireless technology are capable of spontaneously transmitting information, however, the most suitable type of tag will depend on the workstation location, type of workstation, and number of users. Other data communication protocols may be implemented for communication between the wireless identification device and the workstation to ensure data security.

The present system and methodology may be employed for point of sale applications, such as retail sales, gas stations, etc. The present invention could also be used to control access and verify individuals at building entry points, access gates and the like.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for identifying and verifying a user seeking access to a secured workstation comprising the acts of:
spontaneously detecting a first personal identification data set of an intended user associated with a wireless identification device upon positioning of said device within a predetermined proximity of said workstation;
querying at least one database accessible to said workstation by using said first personal identification data set for retrieval of a second personal identification data set, said second personal identification data set further including biometric data corresponding to said intended user;
obtaining biometric data from said user seeking access to said secured workstation from at least one biometric device disposed on said workstation; and
comparing said user obtained biometric data with said second personal identification data set to verify said user as said intended user;
whereby said user seeking access to said secured workstation is identified and verified, thereby permitting access to said secured workstation.

2. The method of claim 1, wherein said first personal identification data set includes account number, pin number, and user name.

3. The method of claim 1, further comprising the act of logging said user into said workstation, upon verification.

4. The method of claim 1, wherein said wireless identification device includes an active tag that is detected by said workstation.

5. The method of claim 1, wherein said wireless identification device includes a passive tag that is detected by said workstation.

6. An identification and verification system for accessing a secured workstation, comprising:
at least one wireless identification device having a processing module for spontaneously communicating a first personal identification data set to a secured workstation located within a predetermined proximity;
said secured workstation having at least one communications port for receiving said first personal identification data set, said workstation including at least one biometric device for obtaining biometric data from said user seeking access thereto; and
at least one database accessible to said workstation and containing said first personal identification data set and a second personal identification data set, said second personal identification containing user biometric data, said workstation having at least one processing module for polling said database and comparing said user obtained biometric data with said second personal identification data;
whereby said user seeking access to said secured workstation is identified and verified thereby permitting access to said secured workstation.

7. The system of claim 6, wherein said first personal identification data set includes account number, pin number, user name.

8. The system of claim 6, wherein said wireless identification device includes an active tag that is detected by said workstation.

9. The system of claim 6, wherein said wireless identification device includes an passive tag that is detected by said workstation.
